(19) United States
(12) Patent Application Publication
(10) Pub. No.: US 2002/0158198 A1
(43) Pub. Date: Oct. 31, 2002

(54) Charged particle beam apparatus

(75) Inventors: Yoshiaki Kohama, Kawasaki-shi (JP); Yukiharu Okubo, Kawasaki-shi (JP)

Correspondence Address: OLIFF & BERRIDGE, PLC, P.O. BOX 19928, ALEXANDRIA, VA, 22320, US

(73) Assignee: NIKON CORPORATION

(21) Appl. No.: 09/800,481

(22) Filed: Mar. 8, 2001

(30) Foreign Application Priority Data
Mar. 13, 2000 (JP) 2000-068027

(51) Int. Cl. G21K 7/00; G01N 23/00

(52) U.S. Cl. 250/307

(57) ABSTRACT

It is an object of the present invention to provide a charged particle beam apparatus which can avoid charge-up without reducing the dose to a sample. For achieving such an object, the charged particle beam apparatus of the present invention is a charged particle beam apparatus comprising irradiating means for irradiating a sample with a charged particle beam, and imaging means for capturing a two-dimensional image of a secondary beam generated from the sample upon irradiation with the charged particle beam; wherein the irradiating means is means for irradiating a partial region within an imaging field of view of the imaging means with the charged particle beam by shaping a cross section of the charged particle beam; the apparatus further comprising moving means for moving the partial region such that the partial region scans the imaging field of view as a whole at least once.

### BACKGROUND OF THE INVENTION

1. Field of the Invention

The present invention relates to a charged particle beam apparatus which irradiates a sample with a charged particle beam such as electron beam or ion beam, captures a two-dimensional image of a secondary beam generated from the sample, and collects image information of the sample.

2. Related Background Art

Along with high integration of LSI in recent years, there has been a demand for further enhancing the sensitivity to detect defects in samples such as wafer and mask. There has also been a demand for speeding up the defect detection in addition to improving the sensitivity to detect defects.

For responding to these demands, EB inspection apparatus using electron beams have been under development. An EB inspection apparatus irradiates a sample with an electron beam, captures a two-dimensional image (sample image) of a secondary beam generated from the sample with an image sensor, and detects defects according to thus captured image information of the sample.

Among such EB inspection apparatus, the one disclosed in Japanese Patent Application Laid-Open No. HEI 10-197462 irradiates, as shown in FIG. 18, a sample 73 with a two-dimensional electron beam 72 having a uniform current density over an area greater than an imaging field of view 71. As a consequence, a sample image is projected onto the imaging surface of an image sensor at once, whereby the image information is collected at a higher speed.

### SUMMARY OF THE INVENTION

In the above-mentioned case where the sample 73 is irradiated with the two-dimensional electron beam 72, so as to collect the image information, electrons are continuously incident on the region of sample 73 from which image information is to be collected at least over the time required for capturing one picture, whereby the sample may be charged up. If the sample 73 is charged up, then distortions and abnormal contrasts may occur in images, so that correct image information may not be collected. The charge-up of sample 73 is a phenomenon in which the amount of electrons incident on the sample 73 is greater than the amount of electrons (secondary beams) emitted from the sample 73. The extent of charge-up varies depending on the composition and surface structure of sample 73.

Though the energy (landing energy) of electrons at the time when they are incident on the sample 73 may be adjusted so as to prevent the charge-up from occurring, the charge-up as a whole is hard to eliminate since the two-dimensional beam 72 has a wide irradiation area, which contains various parts with respective compositions and surface structures.

Though the charge-up can be avoided if the total amount (dose) of electrons incident on the sample 73 is reduced, it is unfavorable since the contrast of images lowers as the dose decreases.

It is an object of the present invention to provide a charged particle beam apparatus which can avoid the charge-up without reducing the dose to a sample.

For achieving such an object, the present invention provides a charged particle beam apparatus comprising irradiating means for irradiating a sample with a charged particle beam, and imaging means for capturing a two-dimensional image of a secondary beam generated from the sample upon irradiation with the charged particle beam; wherein the irradiating means is means for irradiating a partial region within an imaging field of view of the imaging means with the charged particle beam by shaping a cross section of the charged particle beam; the apparatus further comprising moving means for moving the partial region such that the partial region scans the imaging field of view as a whole at least once.

As a consequence, each point of the sample positioned within the imaging field of view is irradiated with the charged particle beam when located within the partial region but not when located outside the partial region. Since the moving means moves the partial region, so that the charged particle beam irradiating the partial region scans an area within the imaging field of view, at least one period under irradiation with the charged particle beam and at least one period without irradiation are included within a time during which one picture is captured by the imaging means.

Therefore, the electric charge charged upon irradiation with the charged particle beam is discharged during a period without irradiation with the charged particle beam. As a result, the sample is prevented from being charged up.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a diagram of an electron beam apparatus 10 in accordance with a first embodiment;

FIG. 2 is a view for explaining a linear irradiation region and an imaging field of view in a viewing mode;

FIG. 3 is a view for explaining a deflection of the path of a primary beam;

FIG. 4 is a view for explaining a sample image projected onto a 2D sensor 44;

FIG. 5 is a view for explaining intermittent illumination caused by a linear beam;

FIG. 6 is a view for explaining continuous illumination caused by a two-dimensional beam;

FIG. 7 is a view for explaining a linear irradiation region and an imaging field of view in an inspection mode;

FIG. 8A is a view for explaining a movement of an inspection region of a sample 15 with respect to an imaging field of view;

FIG. 8B is a view for explaining a movement of the inspection region of sample 15 with respect to the imaging field of view;

FIG. 8C is a view for explaining a movement of the inspection region of sample 15 with respect to the imaging field of view;

FIG. 9 is a schematic view showing the configuration of a TDI sensor 43;

FIG. 10 is a view for explaining another example of irradiation region in an inspection mode;

FIG. 11 is a diagram of an electron beam apparatus 50 in accordance with a second embodiment;

FIG. 12 is a view for explaining an irradiation region having a stripe pattern and an imaging field of view;

FIG. 13A is a view for explaining a movement of the inspection region of sample 15 with respect to the imaging field of view;

FIG. 13B is a view for explaining a movement of the inspection region of sample 15 with respect to the imaging field of view;

FIG. 13C is a view for explaining a movement of the inspection region of sample 15 with respect to the imaging field of view;

FIG. 14 is a view showing an irradiation region having another stripe pattern;

FIG. 15 is a view showing an irradiation region having a lattice pattern;

FIG. 16 is a view showing an irradiation region having a honeycomb pattern;

FIG. 17 is a diagram of an electron beam apparatus 60 in accordance with a third embodiment; and

FIG. 18 is a view for explaining a two-dimensional irradiation region and an imaging field of view.

### DESCRIPTION OF THE PREFERRED EMBODIMENTS

In the following, embodiments of the present invention will be explained in detail with reference to the drawings.

First Embodiment

In a first embodiment, an electron beam apparatus as an example of charged particle beam apparatus will be explained.

The electron beam apparatus 10 in accordance with the first embodiment is an apparatus for observing and inspecting a sample by using an electron beam. The electron beam apparatus 10 is configured so as to be switchable between a viewing mode for acquiring a sample image in a state where a stage is made stationary and an inspection mode for acquiring a sample image at a high speed while moving the stage. The overall configuration of electron beam apparatus 10 will be explained before the individual operation modes.

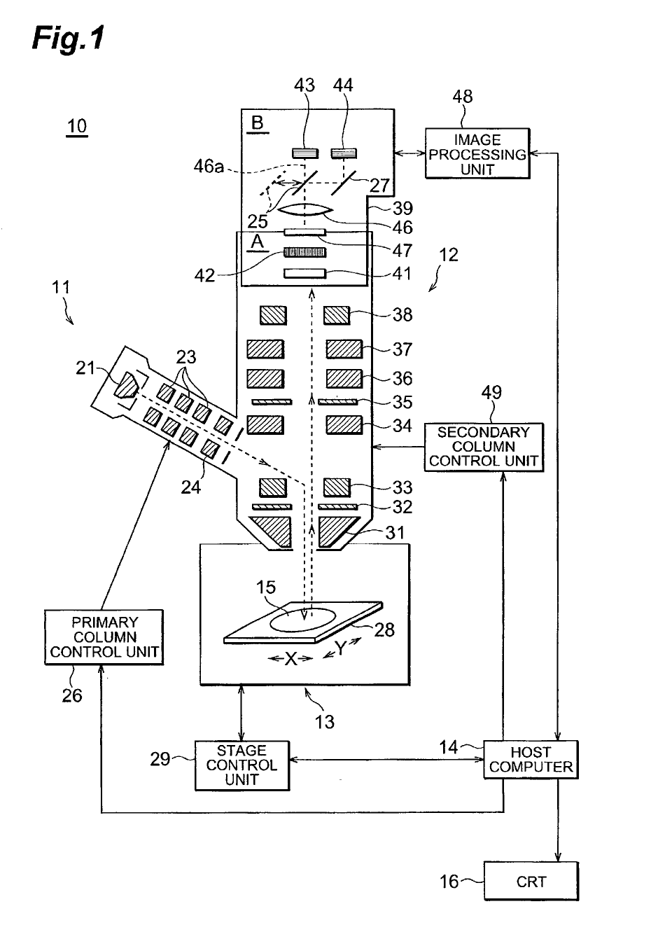

As shown in FIG. 1, the electron beam apparatus 10 is constituted by a primary column 11, a secondary column 12, and a chamber 13. The primary column 11 is obliquely attached to the side face of secondary column 12. The chamber 13 is attached to the lower part of secondary column 12. The primary column 11, secondary column 12, and chamber 13 are evacuated by a turbo pump of an evacuation system (not depicted), so that a vacuum state is maintained therewithin.

The configurations of primary column 11, secondary column 12, and chamber 13 will now be explained individually.

Primary Column

An electron gun 21 is disposed within the primary column 11. The electron gun 21 accelerates and converges thermoelectrons released from a cathode, so as to emit them as an electron beam. Usually used as the cathode for the electron gun 21 is lanthanum hexaboride (LaB₆) which can take out a large current with a rectangular cathode. The electron gun 21 is also provided with a gun alignment mechanism or gun aligner, which is not depicted, for adjusting the position of electron gun 21 and so forth.

Disposed on the optical axis of the electron beam (hereinafter referred to as “primary beam”) emitted from the electron gun 21 are a primary optical system 23 of a three-stage configuration and a primary deflector 24 of a two-stage configuration.

Each stage of the primary optical system 23 is constituted by a quadrupole (or octupole) electrostatic lens (or electromagnetic lens) which is asymmetric about its axis of rotation, and converges or diverges the primary beam as with a so-called cylindrical lens. The primary optical system 23 can shape the cross section of primary beam into a given form (rectangular form, elliptical form, or the like) without losing emitted electrons. In the case where each stage of the primary optical system 23 is an electrostatic lens, the cross section of primary beam is shaped upon optimizing the voltage applied to each electrostatic lens.

The primary deflector 24 is constituted by an electrostatic deflector (or electromagnetic deflector). In the case where the primary deflector 24 is an electrostatic deflector, the path of primary beam can be deflected one-dimensionally or two-dimensionally upon changing the voltage applied to each electrode.

A primary column control unit 26 is connected to the electron gun 21, primary optical system 23, and primary deflector 24 within the primary column 11. The primary column control unit 26 controls the acceleration voltage of electron gun 21, the voltage applied to each stage of the primary optical system 23, and the voltage applied to each electrode of the primary deflector 24. The primary column control unit 26 is connected to a host computer 14.

Chamber

Installed within the chamber 13 is a stage 28 movable in XY directions while mounting a sample 15 thereon. A predetermined retarding voltage is applied to the stage 28.

Also, a stage control unit 29 is connected to the stage 28. While driving the stage 28 in XY directions, the stage control unit 29 reads out XY positions of the stage 28 (at a data rate of 10 Hz, for example) by use of a laser interferometer (not depicted), and outputs an XY positional signal to the host computer 14.

Secondary Column

Within the secondary column 12, a cathode lens 31, a numerical aperture 32, a Wien filter 33, a second lens 34, a field aperture 35, a third lens 36, a fourth lens 37, a secondary deflector 38, and a detector 39 are disposed on the optical axis of a secondary beam (which will be explained later) generated from the sample 15. Among them, the cathode lens 31, second lens 34, third lens 36, and fourth lens 37 are collectively referred to as “secondary optical system” when appropriate.

The cathode lens 31 is constituted by three electrode sheets, for example, such that a predetermined voltage is applied to the first and second electrodes from the lower side (sample 15 side) whereas the third electrode is set to zero potential. Formed between the cathode lens 31 and the sample 15 (stage 28) is an electric field which decelerates the primary beam and accelerates the secondary beam.

The numerical aperture 32 corresponds to an aperture stop and determines the opening angle of cathode lens 31. The numerical aperture 32 is a thin film sheet made of a metal (Mo or the like) having a circular opening, and is disposed such that this opening and the focal position of cathode lens 31 coincide with each other. Consequently, the numerical aperture 32 and the cathode lens 31 constitute a telecentric electronic optical system. Thus realized is Koehler illumination known in optical microscopes.

The Wien filter 33 is a deflector acting as an electromagnetic prism, through which only charged particles (e.g., secondary beam) satisfying a Wien condition (E=vB; where v is the speed of charged particles, E is the electric field, B is the magnetic field, and E⊥B) can travel straight forward, whereas loci of the other charged particles (e.g., primary beam) can be bent.

Each of the second lens 34, third lens 36, and fourth lens 37 is a lens known as a unipotential lens or einzel lens, which is asymmetrical about its axis of rotation and is constituted by three electrode sheets. The lens action of each lens is usually controlled upon changing the voltage applied to the center electrode while the outer two electrodes are set to zero potential.

The field aperture 35 is disposed between the second lens 34 and third lens 36 and restricts the field of view to a necessary range as with the field stop of an optical microscope.

The secondary deflector 38 is a deflector similar to the primary deflector 24. The secondary deflector 38 can deflect the path of secondary beam one-dimensionally or two-dimensionally.

The detector 39 is constituted by an MCP (microchannel plate) 41, a fluorescent plate 42, a view port 47, an optical relay lens 46, a switchable mirror 25, a stationary mirror 27, a TDI (Time Delay and Integration) array CCD sensor (hereinafter referred to as “TDI sensor”) 43, and a two-dimensional CCD sensor (hereinafter referred to as “2D sensor”) 44.

The MCP 41 accelerates and multiplies electrons. The fluorescent plate 42 converts an electronic image into an optical image. The view port 47 is a transparent window which transmits the optical image therethrough while dividing the inside of detector 39 into a vacuum chamber A and an atmospheric chamber B. The optical relay lens 46 reduces the optical image to about ⅓. The switchable mirror 25 is disposed obliquely with respect to the optical axis 46a of optical relay lens 46, while being retractable from the optical axis 46a. The stationary mirror 27 is disposed obliquely on the reflection optical axis of switchable mirror 25. The TDI sensor 43 captures the optical image when the switchable mirror 25 is retracted from the optical axis 46a (in the state indicated by the broken line). The 2D sensor 44 captures the optical image when the switchable mirror 25 is inserted in the optical axis 46a (in the state indicated by the solid line). Each of the TDI sensor 43 and 2D sensor 44 is an image sensor having an imaging surface in which a plurality of light-receiving pixels P are arranged two-dimensionally. An image processing unit 48 is connected to the TDI sensor 43 and 2D sensor 44.

A secondary column control unit 49 is connected to the secondary optical system (31, 34, 36, 37), secondary deflector 38, and switchable mirror 25 of the secondary column 12. The secondary column control unit 48 and image processing unit 49 are connected to the host computer 14. A CRT 16 is connected to the host computer 14.

The loci of primary and secondary beams in the electron beam apparatus 10 of the first embodiment, and so forth will now be explained in sequence.

Primary Beam

The primary beam is emitted with an amount of current corresponding to the acceleration voltage of electron gun 21. The primary beam emitted from the electron gun 21 passes through the primary optical system 23 while being subjected to lens actions, so as to reach the primary deflector 24. When no voltage is applied to the primary deflector 24, the deflecting action of primary deflector 24 is not exerted on the primary beam, whereby the primary beam passes through the primary deflector 24, so as to be made obliquely incident on the center part of Wien filter 33.

The primary beam made incident on the Wien filter 33 bends its locus under the deflecting action of Wien filter 33, thereby reaching the opening of numerical aperture 32. Here, the primary beam forms an image at the opening of numerical aperture 32. Since the numerical aperture 32 and the cathode lens 31 constitute a telecentric optical system, the primary beam forming the image at the opening of numerical aperture 32 is transmitted through the cathode lens 31, so as to become a parallel beam, thereby irradiating the surface of sample 15 perpendicularly and uniformly.

Secondary Beam

When the sample 15 is irradiated with the primary beam, a secondary beam comprising at least one kind selected from a secondary electron, a reflected electron, and a backscattering electron is generated from the sample 15. According to this secondary beam, a two-dimensional image of the irradiation region is constructed. Since the primary beam irradiates the surface of sample 15 perpendicularly as mentioned above, the two-dimensional image of irradiation region becomes a clear image without shadows.

The secondary beam from the sample 15 is subjected to a converging action by the cathode lens 31, so as to pass through the numerical aperture 32 and travel straight forward as it is without being subjected to the deflecting action of Wien filter 33, thereby forming an image at the opening of field aperture 35 by way of the second lens 34. If the electromagnetic field applied to the Wien filter 33 is changed, then an electron (e.g., secondary electron, reflected electron, or backscattering electron) having a specific energy band can selectively be transmitted alone therethrough from the secondary beam.

The secondary beam transmitted through the field aperture 35 is repeatedly converged and diverged by the third lens 36 and fourth lens 37 disposed downstream, so as to be transmitted through the secondary deflector 38, whereby an image is formed again at the detection surface of detector 39.

The secondary beam forming the image again at the detection surface of detector 39 is accelerated and multiplied when transmitted through the MCP 41 within the detector 39, so as to be made incident on the fluorescent plate 42. The secondary beam incident on the fluorescent plate 42 is converted into light thereby. The light from the fluorescent plate 42 forms an image at the imaging surface of TDI sensor 43 or 2D sensor 44 by way of the optical relay lens 46.

Thus, the intermediate image of irradiation region obtained at the opening of field aperture 35 is projected under magnification onto the detection surface of detector 39 by way of the third lens 36 and fourth lens 37, and is converted into an optical image by the fluorescent plate 42, which is then projected onto the imaging surface of TDI sensor 43 or 2D sensor 44. The sample image projected on the imaging surface of TDI sensor 43 or 2D sensor 44 is geometrically similar to the irradiation region.

The sample image projected on the imaging surface is converted into a signal charge by each of the plurality of light-receiving pixels P constituting the imaging surface. Then, the respective signal charges of individual light-receiving pixels P are sequentially transferred in vertical and horizontal directions in response to driving pulses fed from the image processing unit 48, so as to be outputted to the image processing unit 48. The image processing unit 48 A/D-converts the output signals from the TDI sensor 43 or 2D sensor 44, stores thus converted signals into a VRAM therewithin, generates image information of the sample 15, and outputs thus generated information to the host computer 14.

According to the image information outputted from the image processing unit 48, the host computer 14 causes the CRT 16 to display an image. Also, the host computer 14 executes template matching and the like with respect to the image information, thereby specifying defect areas in the sample 15.

Operations of the electron beam apparatus 10 configured as mentioned above will now be explained. The operations of electron beam apparatus 10 include a viewing mode for collecting the image information of sample 15 by using the 2D sensor 44 in a state where the stage 28 is made stationary and an inspection mode for collecting the image information of sample 15 at a high speed by using the TDI sensor 43 while moving the stage 28 at a constant speed. In each mode, the electron beam apparatus 10 is adjusted such that a size of 0.1 μm in the sample 15 corresponds to a single light-receiving pixel P in the imaging surface of TDI sensor 43 or 2D sensor 44.

First, the viewing mode will be explained.

In the viewing mode, the secondary column control unit 49 inserts the switchable mirror 25 into the optical axis 46a of optical relay lens 46 (as indicated by the solid line). As a consequence, the two-dimensional image (optical image) of irradiation region of sample 15 is guided to the 2D sensor 44. In the viewing mode, all the electrical and mechanical setting states of secondary column 12 are held constant.

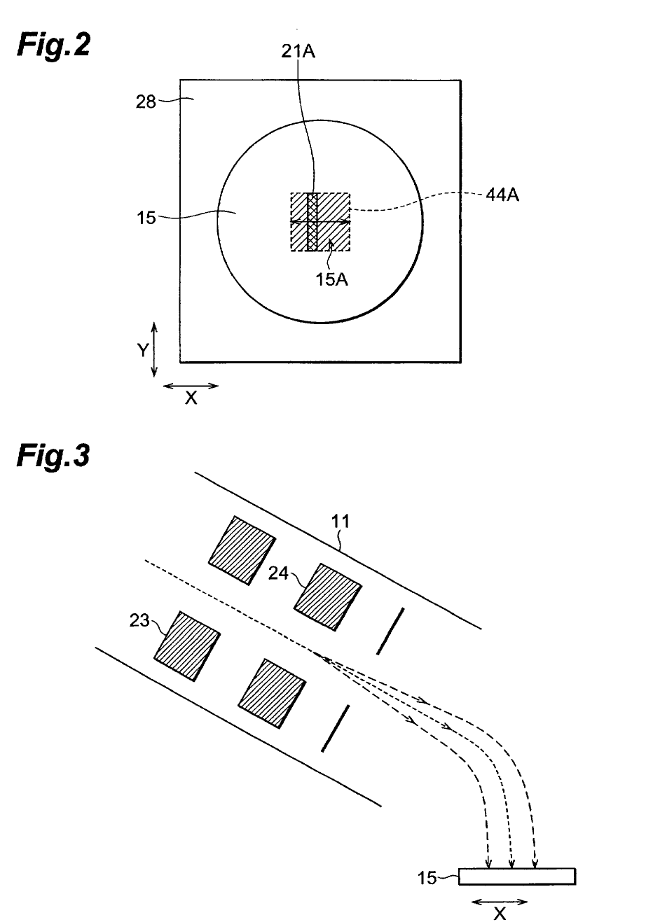

The stage control unit 29 drives the stage 28 in XY directions, so as to position a region to be viewed (e.g., region including a defect area) in the sample 15 into an imaging field of view 44A shown in FIG. 2. After the positioning, the stage 28 is made stationary. In the following, the region of sample 15 positioned within the imaging field of view 44A will be referred to as “viewing region 15A.”

The imaging field of view 44A is a field of view determined by the secondary optical system (31, 34, 36, 37), the optical relay lens 46, and the imaging surface of 2D sensor 44. For example, if the imaging surface of 2D sensor 44 is constituted by 100 pix×100 pix of light-receiving pixels P, then the imaging field of view 44A has a size of 10 μm×10 μm on the surface of sample 15.

On the other hand, the primary column control unit 26 shapes the cross section of primary beam by controlling the voltage applied to the primary optical system 23, so as to set such longitudinal and lateral dimensions (aspect ratio) that the irradiation region 21A (FIG. 2) of primary beam in the surface of sample 15 becomes an elongated rectangle smaller than the imaging field of view 44A. The primary beam guided to the irradiation region 21A is referred to as “linear beam.” The current density of linear beam within the irradiation region 21A is substantially uniform. In the first embodiment, the irradiation region 21A is elongated in Y direction. The length of irradiation region 21A in the longitudinal direction (Y) corresponds to the length of imaging field of view 44A along Y direction. The width of irradiation region 21A corresponds to one line of the imaging field of view 44A.

Further, the primary column control unit 26 deflects the path of linear beam by controlling the voltage applied to the primary deflector 24 (FIG. 3), so as to move the position of irradiation region 21A back and forth within the imaging field of view 44A (see FIG. 2 as well). The back-and-forth movement of irradiation region 21A is carried out one-dimensionally along a direction (X) perpendicular to the longitudinal direction (Y) of irradiation region 21A. Preferably, the speed of back-and-forth movement is constant.

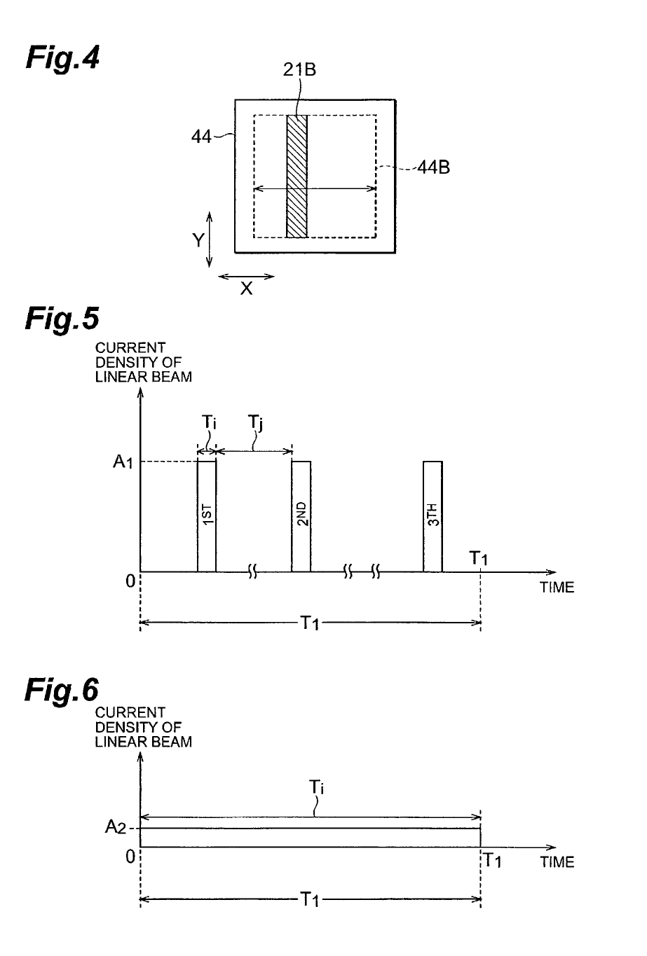

As a result, the viewing region 15A within the imaging field of view 44A is repeatedly scanned with the irradiation region 21A (linear beam) in the electron beam apparatus 10. During the scanning, a narrow rectangular sample image 21B corresponding to the irradiation region 21A moves back and forth in the imaging surface 44B of 2D sensor (FIG. 4), whereby signal charges are stored in the individual light-receiving pixels P of imaging surface 44B.

After the lapse of the time required for the 2D sensor 44 to capture one picture (imaging time T₁), the respective signals stored in the light-receiving pixels P of imaging surface 44B are outputted to the image processing unit 48, whereby image information of the viewing region 15A is collected.

The case where the viewing region 15A is scanned with the irradiation region 21A (linear beam) for N times within the imaging time T₁ of 2D sensor 44 for one picture will now be considered. In this case, each point of the viewing region 15A is intermittently irradiated with the linear beam for N times as shown in FIG. 5. Namely, linear beam irradiation period Tᵢ and non-irradiation period Tⱼ are alternately repeated for n times within the imaging time T₁ for one picture.

Consequently, the electric charge charged by the linear beam during the first irradiation period Tᵢ is discharged during the non-irradiation period Tⱼ until the second linear beam irradiation begins, the electric charge charged by the linear beam during the second irradiation period Tᵢ is discharged during the non-irradiation period Tⱼ until the third linear beam irradiation begins, and so forth, so that the charged electric charges are immediately discharged, whereby the viewing region 15A can be prevented from being charged up.

Assuming that the imaging time T₁ of 2D sensor 44 for one picture is constant, the continuous beam irradiation period Tᵢ per scan becomes shorter as the number of scans (N) of the viewing region 15A with the irradiation region 21A (linear beam) is greater, so that the amount of charge itself within the irradiation period Tᵢ decreases, whereby the charge-up can be avoided more reliably.

The time ratio between the linear beam irradiation period Tᵢ and non-irradiation period Tⱼ is K:(1−K), where K is the area ratio of irradiation region 21A to the imaging field of view 44A (K<1). When K=1/100, for example, 1% is the linear beam irradiation period Tᵢ, whereas 99% is the non-irradiation period Tⱼ that can be utilized for discharging.

The continuous beam irradiation period Tᵢ becomes shorter as the area ratio K of irradiation region 21A to the imaging field of view 44A is smaller, so that the amount of charge itself within the irradiation period Tᵢ decreases as mentioned above, whereby the charge-up can be avoided more reliably. Further, in this case, the non-irradiation period Tⱼ becomes longer as the linear beam continuous irradiation period Tᵢ is shorter, whereby the charged electric charge can be discharged reliably, which is effective in avoiding the charge-up.

Since the linear beam (irradiation region 21A) smaller than the imaging field of view 44A is used for intermittent illumination as in the foregoing, the viewing region 15A can be prevented from being charged up, whereby correct image information without distortion can be collected.

Since whether the image information collected by the 2D sensor 44 has a favorable contrast or not is determined by the total amount (dose) of electrons incident on the viewing region 15A within the imaging time T₁ for one screen, the dose D will now be studied. For collecting image information having a favorable contrast, the dose D must be set to its optimal value (D_{b}).

The dose D is expressed by the product of the amount of current A of linear beam irradiating the viewing region 15A and the imaging time T₁. Consequently, the amount of current A of linear beam will be set to a higher value (e.g., 200 nA) if the dose D is to be set to the optimal value (D_{b}).

Since the linear beam (irradiation region 21A) has a small area, the amount of current (A_{b}) of linear beam set so as to yield the optimal dose (D_{b}) becomes a very high value when converted into a current density A₁. In the electron beam apparatus 10, however, intermittent illumination is carried out by the linear beam (irradiation region 21A), so that the continuous irradiation period Tᵢ of linear beam is short, whereby the amount of charge does not increase extremely within the irradiation period Tᵢ. Also, the electric charge charged within the irradiation period Tᵢ can reliably be discharged within the non-irradiation period Tⱼ, whereby the viewing region 15A can be prevented from being charged up.

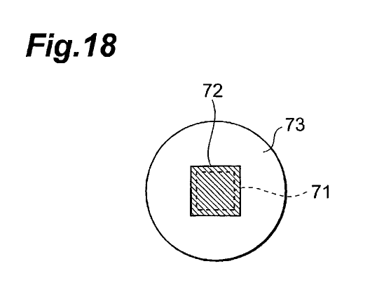

For comparison, the case where the viewing region 15A is irradiated with a two-dimensional beam (see FIG. 18) having a size identical to that of the imaging field of view 44A without moving it will now be considered. When the dose D in this case is set to the above-mentioned optimal value (D_{b}), the amount of current of two-dimensional beam becomes a higher value (e.g., 200 nA) as with the amount of current A of linear beam.

Here, since the two-dimensional beam has a large area (identical to that of the imaging field of view 44A), the amount of current (A_{b}) set for yielding the optimal dose (D_{b}) becomes a small value even when converted into a current density A₂.

In the case where the two-dimensional beam is used, however, electrons are continuously incident on the viewing region 15A over the imaging time T₁ (FIG. 6), so that the electric charge charged in the viewing region 15A cannot be discharged, whereby the charge-up of viewing region 15A is inevitable.

In the electron beam apparatus 10 of first embodiment, by contrast, intermittent illumination is carried out by the linear beam (irradiation region 21A) , so that the viewing region 15A can be prevented from being charged up even when the optimal dose (D_{b}) for collecting image information with a favorable contrast is attained, whereby high-quality image information having a favorable contrast without distortion can be collected.

In the above-mentioned viewing mode, high-quality image information can be collected as in the foregoing when at least one scan is carried out with the linear beam (irradiation region 21A) within the imaging time T₁ (the number of scans N≧1).

The above-mentioned viewing mode is not restricted to the viewing of a region including defect areas of the sample 15. When a predetermined test pattern is viewed, adjustments of apparatus such as focus adjustments and aberration adjustments of the primary optical system 23 and secondary optical system (31, 34, 36, 37) and luminance adjustment in the detector 39 can be carried out. If various kinds of samples having compositions or surface structures different from each other are viewed beforehand, then optimal inspection conditions (such as the aspect ratio and amount of current of linear beam) in the inspection mode, which will be explained in the following, can be set as well.

The inspection mode will now be explained.

In the inspection mode, the switchable mirror 25 is retracted from the optical axis 46a of optical relay lens 46 (as indicated by the broken line). As a consequence, the two-dimensional image (optical image) of irradiation region 21A of sample 15 is guided to the TDI sensor 43.

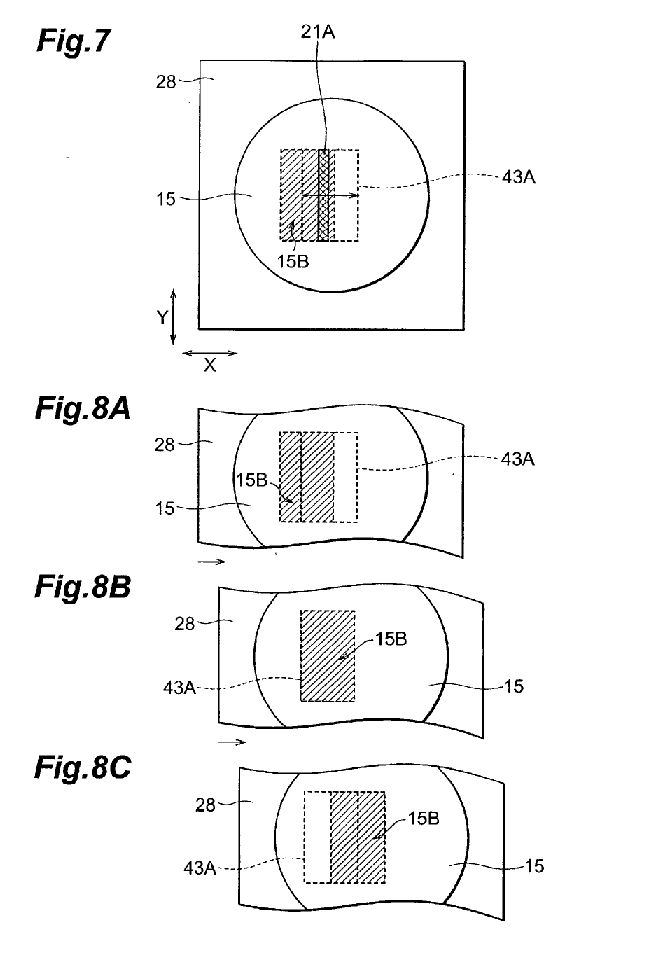

The imaging field of view 43A in this case (FIG. 7) is a field of view determined by the secondary optical system (31, 34, 36, 37), the optical relay lens 46, and the imaging surface of TDI sensor 43. If the imaging surface of TDI sensor 43 is constituted by 2000 pix×500 pix of light-receiving pixels P, for example, then the imaging field of view 43A has a size of 200 μm×50 μm on the surface of sample 15.

The stage 28 for mounting the sample 15 is moved in one direction (X) at a constant speed. Here, the region to be inspected in the sample 15 moves across the imaging field of view 43A. The following explanation will take account of one picture (referred to as “inspection region 15B”) in the region to be inspected in the sample 15. Along with the movement of stage 28, the inspection region 15B moves across the imaging field of view 43A as shown in FIGS. 8A to 8C.

When the stage 28 moves, the stage control unit 29 outputs to the host computer 14 a positional signal of the stage 28 detected by use of a laser interferometer (not depicted). The host computer 14 controls the image processing unit 48 in synchronization with the positional signal of stage 28, so as to drive the TDI sensor 43.

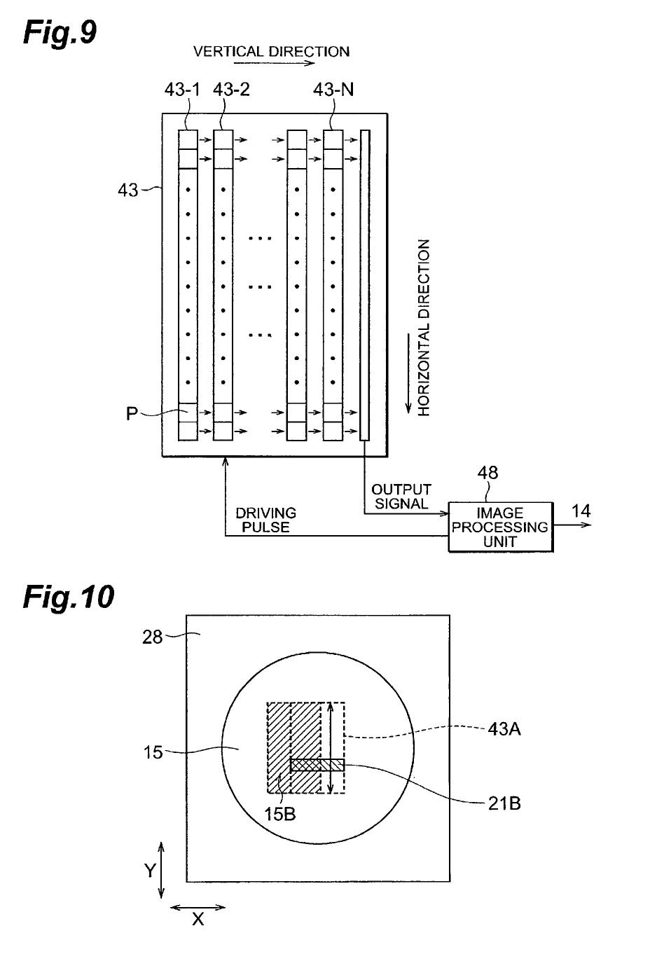

In the TDI sensor 43 (FIG. 9), the respective signal charges of individual light-receiving pixels P are sequentially transferred in vertical and horizontal directions in response to driving pulses fed from the image processing unit 48, so as to be outputted to the image processing unit 48. The vertical transfer of signal charges is carried out for each of horizontal lines 43-1 to 43-N in synchronization with the above-mentioned movement (FIGS. 8A to 8C) of stage 28 (inspection region 15B). Consequently, the signal charges stored in the individual horizontal lines 43-1 to 43-N of TDI sensor 43 are integrated every time when they are transferred to the respective adjacent horizontal lines in the vertical direction.

Thus, while the movement of stage 28 (inspection region 15B) and the vertical transfer of signal charges in the TDI sensor 43 are controlled in synchronization with each other, the inside of imaging field of view 43A is repeatedly scanned in the inspection mode by use of a linear beam (irradiation region 21A) similar to that in the above-mentioned viewing mode (FIG. 7). The linear beam in the inspection mode is shaped such that the irradiation region 21A becomes an elongated rectangle smaller than the imaging field of view 43A. The irradiation region 21A has dimensions of 200 μm in the longitudinal direction (Y) and 1 μm in the widthwise direction (X). The longitudinal direction (Y) of irradiation region 21A aligns with the horizontal direction of TDI sensor 43.

If the inside of imaging field of view 43A is repeatedly scanned with such a linear beam (irradiation region 21A), then a thin rectangular sample image corresponding to the irradiation region 21A moves back and forth in the vertical direction (see FIG. 4) in the imaging surface 43B of TDI sensor 43 (FIG. 9), whereby signal charges are stored into individual light-receiving pixels P of the imaging surface 43B.

Simultaneously, the vertical transfer of respective signal charges stored in the individual light-receiving pixels P of imaging surface 43B and the horizontal transfer of signal charge of the last horizontal line 43-N are controlled in synchronization with the movement of stage 28 (inspection region 15B).

At the point where the imaging time T₂ for the TDI sensor 43 to capture one picture has passed, image information of the inspection region 15B is assumed to be collected in the image processing unit 48.

Since intermittent illumination is thus carried out by use of the linear beam (irradiation region 21A) smaller than the imaging field of view 43A, the inspection region 15B can be prevented from being charged up, whereby correct image information without distortion can be collected in the inspection mode as well.

Even in the case where an optimal dose (D_{b}) for collecting image information having a favorable contrast is attained, the inspection region 15B can be prevented from being charged up, whereby high-quality image information having a favorable contrast without distortion can be collected.

Further, in the inspection mode, image information of the sample 15 is collected while the stage 28 is moved at a high speed, whereby image information can be taken out continuously in a short time from a relatively large region of the sample 15 or the whole area thereof.

Though there is a possibility of minute positional deviations (1 μm or less) occurring in the sample image because of fluctuations in speed or mechanical vibrations of the stage 28, the positional deviations of sample image can be corrected when a position correcting voltage is supplied to the secondary deflector 38.

When the inside of imaging field of view 43A is repeatedly scanned with the linear beam (irradiation region 21A) in the above-mentioned inspection mode (FIG. 7), it is preferred that this scanning and the vertical transfer of signal charges in the TDI sensor 43 be controlled in synchronization with each other.

The synchronized control in this case is also based on the above-mentioned positional signal outputted from the stage control unit 29 to the host computer 14 when the stage 28 is moved. The above-mentioned positional signal is used for the movement of stage 28 and the vertical transfer in the TDI sensor 43.

In synchronization with the above-mentioned positional signal, the host computer 14 controls the primary column control unit 26, so as to change the voltage applied to the primary deflector 24, whereby the repeated scanning (FIG. 7) with the linear beam (irradiation region 21A) and the vertical transfer in the TDI sensor 43 (FIG. 9) can be controlled in synchronization with each other. As a result, the linear beam (irradiation region 21A) is scanned at least once between one vertical transfer to the next vertical transfer in the TDI sensor 43. Consequently, the dose to the inspection region 15B becomes uniform, which can eliminate irregularities in illumination with the linear beam (irradiation region 21A).

Though the above-mentioned inspection mode relates to an example (FIG. 7) in which the longitudinal direction of linear beam (irradiation region 21A) aligns with the horizontal direction (Y) of TDI sensor 43, a linear beam (irradiation region 21B ) elongated in the vertical direction (X) of TDI sensor 43 can be used as well (FIG. 10). The irradiation region 21B may have dimensions of 50 μm in the longitudinal direction (X) and 1 μm in the widthwise direction (Y), for example. If scanning with the linear beam (irradiation region 21B) is carried out along the direction (Y) perpendicular to the longitudinal direction (X) in this case, then high-quality image information having a favorable contrast without distortion can be collected as in the foregoing.

Though the above-mentioned first embodiment (including its viewing mode and inspection mode) explains an elongated rectangular linear beam by way of example, an elongated elliptical linear beam may be used as well. The width of linear beam may also extend over a plurality of lines instead of one line. Without being restricted to elongated linear beams, a spot-like beam can be used as well. If scanning with a spot-like beam is carried out in two-dimensional directions (X, Y) in this case, then high-quality images can be collected as in the foregoing. The aspect ratio of linear beam or spot-like beam (primary beam) may be set according to the composition or surface structure of sample 15 (within the range of 10:1 to 1000:1).

Second Embodiment

The electron beam apparatus 50 in accordance with a second embodiment has a configuration identical to that of the electron beam apparatus 10 (FIG. 1) mentioned above except that an aperture-constituting plate 51 is disposed within the primary column 11 of electron beam apparatus 10, whereas the 2D sensor 44, switchable mirror 25, and stationary mirror 27 are omitted.

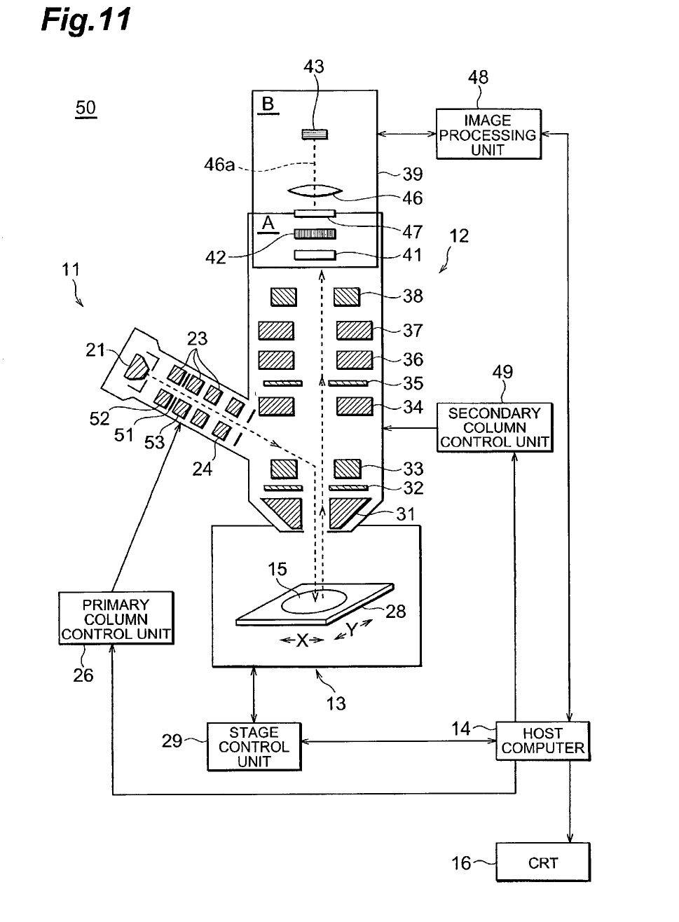

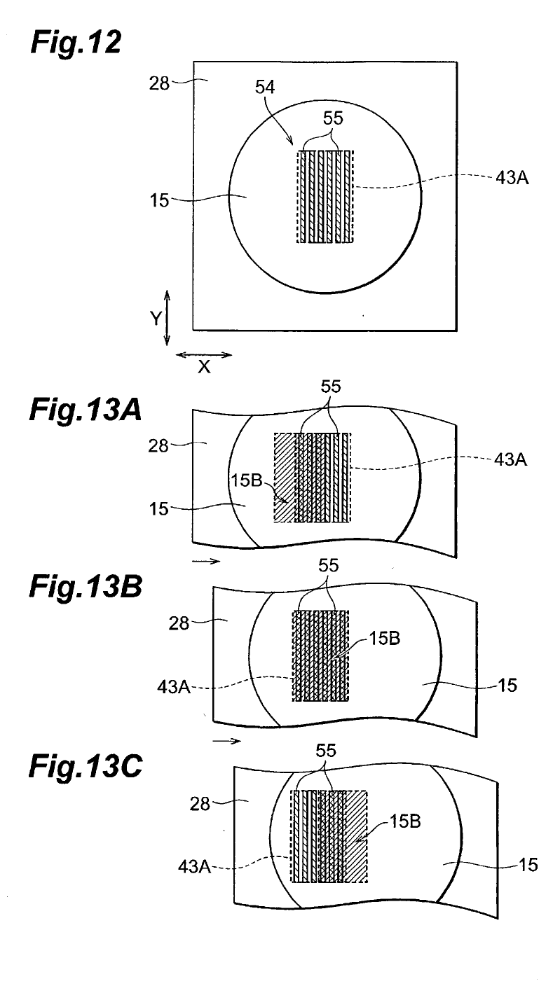

As shown in FIG. 11, the aperture-constituting plate 51 of electron beam apparatus 50 is disposed between a first-stage electron lens 52 and a second-stage electron lens 53 in the primary optical system 23. In the aperture-constituting plate 51, a plurality of slit-like openings are arranged at equally spaced intervals. consequently, as shown in FIG. 12, the primary beam forms an irradiation region 54 (partial region) in the surface of sample 15 having a stripe pattern in which a plurality of elongated irradiation sections are arranged regularly at constant intervals. The longitudinal direction (Y) of each irradiation section 55 aligns with the horizontal direction of TDI sensor 43 (FIG. 9). The outer shape of irradiation region 54 has a size substantially the same as that of the imaging field of view 43A. The primary beam is emitted such that the outer shape of irradiation region 54 coincides with the imaging field of view 43A.

The electron beam apparatus 50 collects the image information of sample 15 by using the TDI sensor 43 without deflecting the path of primary beam. Since the path of primary beam is not deflected, the outer shape of irradiation region 54 keeps coinciding with the imaging field of view 54 during the collection of image.

Here, since the stage 28 for mounting the sample 15 is moved in one direction (X) at a constant speed in synchronization with the vertical transfer of signal charge in the TDI sensor 43, the inspection region 15B of sample 15 moves across the irradiation region 54 (a plurality of irradiation sections 55) as shown in FIGS. 13A to 13C. As a result, each point of the inspection region 15B is intermittently irradiated with the primary beam every time when passing the individual irradiation sections 55 of irradiation region 54. Namely, during the imaging time T₂ of TDI sensor 43 for one picture, primary beam irradiation period Tᵢ and non-irradiation period Tⱼ are alternately repeated (see FIG. 5).

The primary beam irradiation period Tᵢ corresponds to the width of irradiation section 55, whereas the non-irradiation period Tⱼ corresponds to the interval between adjacent irradiation section 55 (width of their gap). The number of repetitions is equal to the number of irradiation sections 55 constituting the irradiation region 54.

Since a plurality of irradiation sections 55 irradiate the primary beam intermittently as such, the electric charge charged during the irradiation period Tᵢ is discharged during the non-irradiation period Tⱼ, whereby the inspection region 15B can be prevented from being charged up. As a result, high-quality image information having a favorable contrast without distortion can be collected.

It is preferred that the irradiation sections 55 be narrower, since it makes each primary beam continuous irradiation period Tᵢ shorter, whereby the charge-up can be avoided reliably. Also, the stripe pattern becomes finer as the number of irradiation sections 55 constituting the irradiation region 54 is greater, whereby irregularities in brightness of an image can be flattened.

Though the foregoing explains an example in which the longitudinal direction (Y) of each irradiation section 55 constituting the irradiation section 54 is perpendicular to the moving direction (X) of stage 28, it is not restrictive. For example, each point of the inspection region 15B of sample 15 can also be intermittently irradiated with the primary beam by use of an irradiation area 56 in which the longitudinal direction of each irradiation section 57 is arranged oblique with respect to the moving direction (X) of stage 28 as shown in FIG. 14, whereby high-quality image information can be collected.

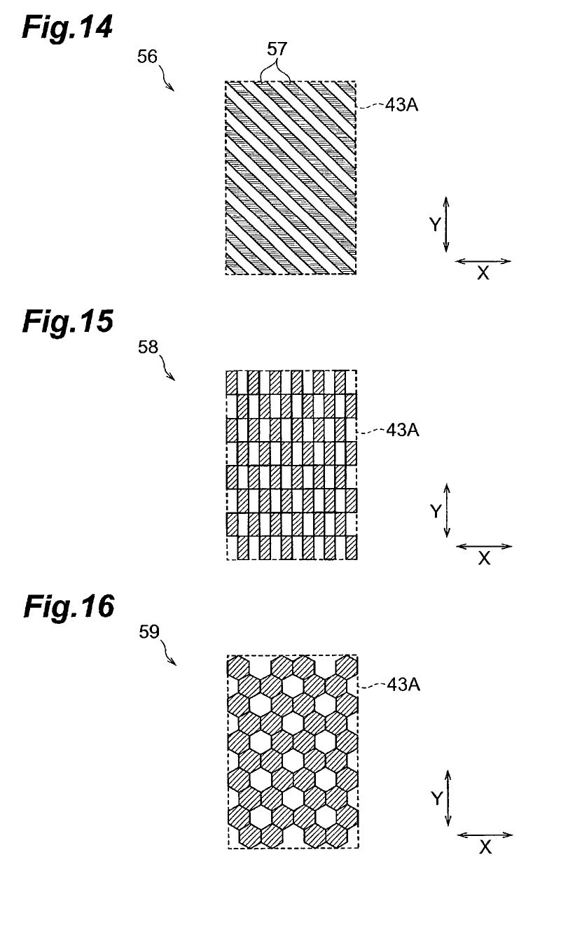

Without being restricted to the irradiation regions 54, 56 having stripe patterns, an irradiation region 58 having a lattice pattern shown in FIG. 15, an irradiation region 59 having a honeycomb pattern shown in FIG. 16, or an irradiation region having a mesh pattern can also intermittently irradiate each point of the inspection region 15B with the primary beam, whereby high-quality image information can be collected.

Since the amount of current of primary beam integrated in the moving direction (X) of stage 28 becomes constant in each of the above-mentioned irradiation regions 56, 58, 59, images having no irregularities in brightness can be collected by the TDI sensor 43. For realizing these irradiation regions 56, 58, 59, it will be sufficient if aperture-constituting members in which openings adapted to form the respective patterns are arranged are provided in place of the aperture-constituting member 51 of electron beam apparatus 50.

If a correcting voltage is supplied to the primary deflector 24 within the primary column 11, so as to deflect the path of primary beam, thereby vibrating the irradiation regions 56, 58, 59 in a direction (Y) perpendicular to the moving direction (X) of stage 28, then irregularities in brightness can further be reduced.

The outer shapes of irradiation regions 54, 56, 58, 59 may be smaller or larger than the imaging field of view 43A.

Third Embodiment

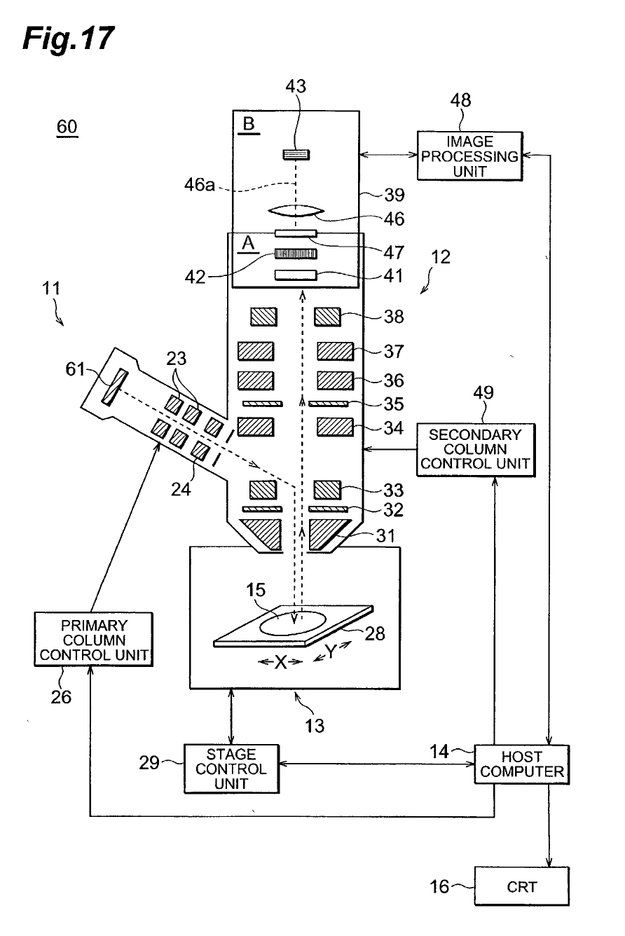

In the electron beam apparatus 60 of a third embodiment, as shown in FIG. 17, a two-dimensional electron gun array 61 is provided in place of the electron gun 21 of the electron beam apparatus 50 (FIG. 11) mentioned above, the aperture-constituting plate 51 is omitted, and the primary optical system 23 has a two-stage configuration. Except for these differences, it has the same configuration as that of the electron beam apparatus 50.

The electron gun array 61 of electron beam apparatus 60 is constituted by a field-emission electron gun array, for example. The electron gun array 61 can freely change its emission pattern. Examples of the emission pattern include the above-mentioned stripe patterns (FIGS. 12 and 14), lattice pattern (FIG. 15), and honeycomb pattern (FIG. 16).

The irradiation region of primary beam in the surface of sample 15 is substantially the same as the emission pattern of electron gun 61. consequently, as in the electron beam apparatus 50 mentioned above, each point of the inspection region 15B of sample 15 can be irradiated intermittently with the primary beam when the stage 28 is moved in one direction (X). As a result, the inspection region 15B can be prevented from being charged up, whereby high-quality images having a favorable contrast without distortion can be collected.

The electron beam apparatus 60 can change the pattern of irradiation region by changing the emission pattern of electron gun 61 alone without replacing any component.

If the emission pattern is vibrated on the electron gun array 61 in a direction (Y) perpendicular to the moving direction (X) of stage 28, then irregularities in brightness can be reduced.

Though each of the above-mentioned embodiments explains an electron beam apparatus in which the cathode lens 31, Wien filter 33, and the like are commonly used in the path (primary beam system) through which the sample 15 is irradiated with the primary beam and the path (secondary beam system) through which the secondary beam from the sample 15 reaches the detector 39, the primary beam system and the secondary beam system may be independent from each other, each comprising a cathode lens.

The present invention is also applicable to apparatus (charged particle beam apparatus) using charged particle beams (ion beams and the like) other than the electron beams.

As in the foregoing, the charged particle beam apparatus of the present invention can secure charged particle beam irradiation period Tᵢ and non-irradiation period Tⱼ at least one by one within the imaging time of imaging means for one picture, whereby the charge caused by irradiation with a charged particle beam can be discharged during the non-irradiation period Tⱼ. As a result, the sample is prevented from being charged up, whereby high-quality image information can be collected.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A charged particle beam apparatus comprising irradiating means for irradiating a sample with a charged particle beam, and imaging means for capturing a two-dimensional image of a secondary beam generated from said sample upon irradiation with said charged particle beam;
wherein said irradiating means is means for irradiating a partial region within an imaging field of view of said imaging means with said charged particle beam by shaping a cross section of said charged particle beam;
said apparatus further comprising moving means for moving said partial region such that said partial region scans said imaging field of view as a whole at least once.

2. A charged particle beam apparatus according to claim 1, wherein said partial region irradiated with said charged particle beam has an outer shape smaller than said imaging field of view.

3. A charged particle beam apparatus according to claim 2, wherein said partial region has a linear outer shape.

4. A charged particle beam apparatus according to claim 1, wherein said partial region comprises a plurality of divided sections arranged at a predetermined interval therebetween.

5. A charged particle beam apparatus according to claim 4, wherein said plurality of regions are arranged regularly.

6. A charged particle beam apparatus according to claim 1, wherein said moving means has deflecting means for moving a position of said partial region by deflecting a path of said charged particle beam.

7. A charged particle beam apparatus according to claim 1, further comprising:
a stage, movable parallel to an imaging surface of said imaging means, for mounting said sample; and
control means for synchronizing imaging carried out by said imaging means and moving of said stage with each other.
